(19) United States
(12) Patent Application Publication
(10) Pub. No.: US 2015/0349325 A1
(43) Pub. Date: Dec. 3, 2015

(54) BI-FUNCTIONAL ELECTRODE FOR METAL-AIR BATTERIES AND METHOD FOR PRODUCING SAME

(71) Applicants: Zhongwei CHEN, Waterloo (CA); Dong Un LEE, Etobicoke (CA); Woong Hey PARK, Kitchener (CA); Kun FENG, Waterloo (CA)

(72) Inventors: Zhongwei Chen, Waterloo (CA); Dong Un Lee, Etobicoke (CA); Hey Woong Park, Kitchener (CA); Kun Feng, Waterloo (CA)

(21) Appl. No.: 14/654,256

(22) PCT Filed: Dec. 20, 2013
(86) PCT No.: PCT/CA2013/051008

§ 371 Date: Jun. 19, 2015

Related U.S. Application Data
(60) Provisional application No. 61/797,981, filed on Dec. 20, 2012.

(51) Int. Cl. H01M 4/04; H01M 4/86; H01M 12/08; H01M 4/88

(52) U.S. Cl. CPC H01M 4/0497; H01M 4/88; H01M 4/8615; H01M 12/08; H01M 4/0471

(57) ABSTRACT

A method of producing a bi-functional electrode for a metal-air battery or fuel cell comprises growing metal oxide nanowires directly on a metal support using a chemical deposition process. Preferably, the chemical process comprises an ammonium evaporation process. The metal support is preferably a porous metal structure, such as a metal mesh or foam. The metal oxide nanowires are formed of any transition metal or mixed transition metal. Preferably, the nanowires comprise cobalt oxide nanowires.

### CROSS REFERENCE TO PRIOR APPLICATIONS

The present application claims priority under Paris Convention to U.S. Application No. 61/797,981, filed Dec. 20, 2012, the entire contents of which are incorporated herein by reference.

### FIELD OF THE INVENTION

The present invention generally relates to electrodes for metal-air batteries. In particular, the invention relates to electrodes having deposited thereon, a catalyst in the form of metal oxide nanowires.

### BACKGROUND OF THE INVENTION

With the emergence of electric and hybrid electric vehicles, advanced energy generation and storage systems have become one of the focal points of scientific research. Metal-air battery technologies such as zinc-air and lithium-air batteries offer extremely high theoretical energy capacities, making them excellent candidates as range extenders for these next generation vehicles.^{[1-6]} Especially zinc-air batteries are affordable, safe, and environmentally benign, ideally suited for a wide range of applications. However, for rechargeable battery applications, one of the main challenges associated with the commercialization of zinc-air batteries is the development of electrocatalysts with high bi-functionality in order to efficiently catalyze both the oxygen reduction reaction (ORR) and oxygen evolution reaction (OER).^{[2, 7, 8]} To date, efficient ORR and OER processes, which correspond to discharge and charge reactions of a rechargeable zinc-air battery, have been realized by the use of precious metal-based catalysts such as carbon supported platinum and iridium.^{[9-12]} However, the scarcity and electrochemical instability of these catalysts have prevented the realization of wide commercialization due to extremely high costs and lack of long term durability.^{[13, 14]}

The conventional preparation of air breathing cathodes for zinc-air batteries requires physical deposition of active material onto a carbon gas diffusion layer (GDL) by methods such as drop-casting or spray-coating.^{[2, 7, 15]} These physical processes, however, require the use of ancillary materials such as carbon black, pore forming agents, and polymer binders, which often cause negative impact on the battery's performance. Especially for rechargeable battery applications, carbon present in the air cathode spontaneously undergoes side reactions such as carbon corrosion during high potentials associated with recharging of the battery that leads to the degradation of the electrode, greatly reducing the cycle life of a battery.^{[16, 17]}

To address the above mentioned deficiency in known methods, Cohen-Hyams et al. (T. Cohen-Hyams et al., “Synthesis of NiO Nanowires For Use in Lithium Batteries”, ECS Transactions, 11 (31), 2008, 1-7) (the entire contents of which are incorporated herein by reference) teaches a method of providing NiO nanowire catalysts directly onto the surface of a current collector for LiO batteries. This reference specifically teaches the use of an electrochemical method for the deposition of the nanowire catalyst onto the electrode surface. However, such electrochemical processes are not economical. For example, electrochemical deposition method require considerable equipment and operating costs to provide the require potential for the process to function.

There exists a needs for an improved method of producing an electrode for a metal air battery that overcomes at least one of the deficiencies known in the art.

### SUMMARY OF THE INVENTION

In one aspect, the present invention provides a method of manufacturing a bi-functional electrode comprising:
providing a porous metal substrate; and,
chemically growing metal oxide nanowires on the metal substrate.

### BRIEF DESCRIPTION OF THE DRAWINGS

The features of the invention will become more apparent in the following detailed description in which reference is made to the appended drawings wherein:

FIG. 1a to 1i: (a) Schematic illustration of the growth of 3D rechargeable Co₃O₄ NW air cathode for bi-functional catalysis of ORR and OER. SEM images of (b) SS mesh current collector prior to the growth, (c) densely coated Co₃O₄ NW array, (d) surface morphology of Co₃O₄ NW, (e) self-standing Co₃O₄ NW array, and (f) cross-section of Co₃O₄ NW. (g) TEM image of mesoporous Co₃O₄ NW wall. (h) HR-TEM image of the Co₃O₄ NW wall (inset: FFT pattern of Co₃O₄ NW exhibiting polycrystallinity). (i) Optical image of flexible as-grown Co₃O₄ NW air electrode.

FIGS. 2a to 2d: (a) Galvanodynamic discharge and charge polarization curves obtained by using air in ambient condition of Co₃O₄ NW grown on SS mesh (red square), Co₃O₄ NW sprayed on GDL (blue circle), and Pt/C sprayed on GDL (black triangle). Galvanostatic pulse cycling at 50 mA using air in ambient condition of (b) Co₃O₄ NW grown on SS mesh, (c) Co₃O₄ NW sprayed on GDL, and (d) Pt/C sprayed on GDL.

FIG. 3 illustrates Nyquist plots obtained by electrochemical impedance spectroscopy using air in ambient condition of Co₃O₄ NW grown on SS mesh (red square), Co₃O₄ NW sprayed on GDL (blue circle), and Pt/C sprayed on GDL (black triangle). (Inset: High frequency range of the Nyquist plot, and the equivalent circuit).

FIG. 4 illustrates extended practical zinc-air battery cycling tests using air in ambient condition of (a) Co₃O₄ NW grown on SS mesh, (b) Co₃O₄ NW sprayed on GDL, and (c) Pt/C sprayed on GDL.

### DETAILED DESCRIPTION OF THE INVENTION

The terms “comprise”, “comprises”, “comprised” or “comprising” may be used in the present description. As used herein (including the specification and/or the claims), these terms are to be interpreted as specifying the presence of the stated features, integers, steps or components, but not as precluding the presence of one or more other feature, integer, step, component or a group thereof as would be apparent to persons having ordinary skill in the relevant art.

In general, the invention provides, in one aspect, a bi-functional electrode comprising metal oxide nanowires. In another aspect, the invention provide a facile method of depositing the metal oxide nanowires directly onto a metal support. The electrodes formed according to the method of the invention may be used in primary or secondary metal-air batteries or metal-air fuel cells. Thus, in one aspect, the invention provides a bi-functional electrode for use in primary or secondary metal-air batteries or metal-air fuel cells, which comprises (a) electro-catalytically active metal oxide nanowires, and (b) highly electric conductive metal support upon which the nanowires are directly grown by a facile method. The method utilizes fast and simple procedure over other various methods of nanowires synthesis, and the direct growth of nanowires onto a metal support greatly simplifies electrode fabrication procedure. The metal support not only provides good electrical contact with the nanowires for faster charge transfer, but is also not susceptible to carbon corrosion, which, as discussed above, is a common issue encountered with carbon-based gas diffusion layers used in the traditional electrode preparation.

In one aspect, the invention comprises the growth of metal oxide nanowires directly on a metal support using a facile chemical method. The resulting structure can be used as an electrode in metal-air battery and fuel cell applications without the additional process of depositing electro-catalysts onto a gas diffusion layer. Briefly, a metal support of a desired size is preferably cleaned by ultrasonication and rinsed with a solvent. A reaction solution is then prepared by dissolving an amount of the required metal precursors in the solvent. The solution is pre-heated to a desired reaction temperature then the prepared metal support is immersed into the solution for a duration of time for the reaction to occur. Finally, the metal support is heat treated in air to complete the formation of metal oxide nanowires on the metal support.

In one embodiment, the metal oxide nanowires of the invention are grown by a simple chemical method as opposed to more complicated and expensive routes such as chemical vapor deposition (CVD) or electro-chemical deposition.

Examples of metal oxide nanowires that can be used in the present invention include any transition metal oxides, such as cobalt oxide, tin oxide, titanium oxide, nickel oxide, as well as mixed transition metal oxides, such as nickel cobalt oxide, cobalt manganese oxide, etc. The metal oxides exhibit a wire-like morphology with roughened surface which contribute to the increased overall surface area. This in turn increases the number of reaction sites available for the oxygen reactions thereby enhancing the electrochemical performance in metal-air battery and fuel cell applications. In accordance with the present invention, the roots of the nanowires are in direct contact with the metal support, which not only acts as the growth support or substrate for the metal oxide nanowires, but also as the current collector during the operation of the cell.

In one aspect, the metal support allows the direct growth of the nanowires, which significantly simplifies the electrode fabrication process by eliminating the step of depositing an electrocatalyst onto a gas diffusion layer. Generally, the metal support, or substrate that can be used in the present invention comprises any porous metal or metal alloy that is capable of conducting current. Examples of the porous structure of the substrate include metal mesh, metal foam etc. Specific examples of metal supports for use in the invention include stainless steel mesh, nickel foam, copper foam, porous aluminum, etc. The porous nature of the metal support, as opposed to film or sheet like substrate, allows the diffusion of air into the electrode to allow oxygen reactions. Traditionally, electrocatalysts have been deposited onto a carbon based porous gas diffusion layer; however, as discussed above carbon corrosion occurs due to reaction with electrolyte during device operation which severely degrades the performance and durability of the battery and fuel cell. The use of more chemically resistant metal supports such as stainless steel eliminates or reduces the possibility of side reactions that may have a negative impact on the performance of the battery and fuel cell.

In a preferred embodiment of the invention, as mentioned above, the nanowires are grown on a metal substrate using a chemical process that is simple and effective. That is, the chemical process is one which results in the initiation and growth of nanowires on the substrate using a chemical reaction without the need for an external driving force, such as a voltage, as would be needed in electro-chemical deposition processes. In one preferred embodiment, the invention utilizes an oxidizing agent such as a strong base to form and propagate the metal oxide nanotubes on the metal substrate. Such oxidizing agents may preferably comprise hydroxides such as ammonium hydroxide, sodium hydroxide or potassium hydroxide. Ammonium hydroxide is particularly preferred since, once the nanowire formation is completed, an evaporation process (i.e. an ammonium evaporation process) may be used to remove the remaining hydroxide solution.

In one aspect of the invention, the aforementioned chemical reaction involves combining, into an aqueous solution, a metal salt (i.e. a salt of the desired metal for the metal oxide material), and a hydroxide, preferably ammonium hydroxide. The solution is preheated to about 25° to 200° C. preferably for a period of time of about 20 minutes to one hour. In a preferred embodiment, the solution is preheated to 90° C. Once the desired temperature is reached, the metal substrate is immersed in the solution. The reaction is then allowed to continue by maintaining the substrate in the solution for a period of time, such as 5 hours. The temperature of the solution is maintained to that indicated above, i.e. about 25° to 200° C. and preferably 90° C. After this period of time, the metal substrate is removed and dried with heated air to complete the nanowire formation and also the evaporate the remaining hydroxide solution. This final heat treatment step is conducted for a period of about 30 minutes to 2 hours and at a temperature of about 200° to 300° C.

### EXAMPLES

The invention will now be described with reference to specific examples. It will be understood that the following examples are intended to illustrate the invention and are not to be construed as limiting the scope of the invention in any way.

### Example 1

### Growth of Cobalt Oxide Nanowires on Stainless Steel Mesh

A stainless steel mesh was cleaned under ultrasonication for ten minutes. Then, cobalt nitrate and ammonium nitrate are dissolved in water and ammonium hydroxide is further added to prepare the reaction solution. The reaction solution was pre-heated in an oven then the clean stainless steel mesh was immersed in the solution and kept heated for a period of time for the reaction to continue. Finally, the metal support was heat treated in air to complete the formation of cobalt oxide nanowires on stainless steel.

### Example 2

### Characterization of Electrode

The electrode (i.e. cobalt oxide on stainless steel mesh) of Example 1 was characterized using a scanning electron microscope to confirm its structure and morphology. The nanowire structures were clearly observed stemming from the stainless steel mesh metal support and with average diameter of 300 nm, which confirmed the successful synthesis of metal oxide nanowires using this direct method. X-ray diffraction analysis was used to confirm the growth of cobalt oxide, Co₃O₄, nanowires grown on the stainless steel mesh.

### Example 3

### Performance of Electrode

The performance of the electrode of Example 1 was demonstrated by its use as a bi-functional electrode in a zinc air battery. A zinc metal plate was used as the opposite electrode and 6M KOH was used as the electrolyte. The galvanodynamic test of the battery from 0 to 200 mA for both discharge and charge showed high electrochemical activity of the cobalt oxide nanowires on stainless steel mesh. Furthermore, cycling the battery (repeated discharge/charge) at 50 mA demonstrated excellent discharge and charge potentials and durability up to 100 cycles.

### Example 4

### Manufacture and Characterization of Further Electrode

To address the issues noted above with respect to the conventional preparation of air electrodes, we completely removed the use of ancillary materials by directly growing a Co₃O₄ nanowire (NW) array as the active material onto the surface of a stainless steel (SS) mesh current collector. The direct growth has several advantages over the conventional methods. Firstly, Co₃O₄ NW directly grown on SS mesh current collector drastically simplifies the electrode design and fabrication procedure since time-consuming physical deposition processes are no longer required, allowing highly practical and scalable preparation of the electrode. Secondly, non-conductive ancillary binding material removed from the electrode not only enhances the electrical property, but also improves the electrochemical stability since the decomposition of the binder can be avoided. Lastly, SS mesh not only acts as support for the growth of Co₃O₄ NW, but also plays the role of a current collector, simplifying the battery design thereby significantly reducing its internal resistance. Using this advanced electrode, remarkable rechargeability and durability of a practical zinc-air battery have been demonstrated by utilizing natural air as the source of fuel instead of pure purged oxygen.

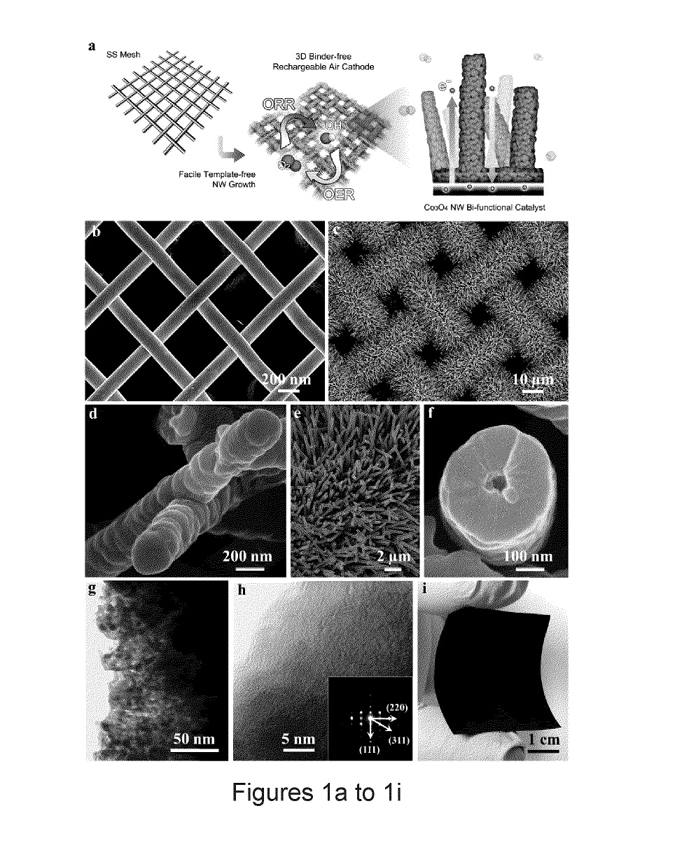

The facile template-free method was used to grow mesoporous Co₃O₄ NW array directly onto a SS mesh current collector to be used as an air cathode in rechargeable zinc-air batteries without further processing (FIG. 1a). The bare SS mesh current collector was observed to be densely coated with Co₃O₄ NW after the growth, creating a 3D binder-free, and self-standing NW array (FIG. 1b, 1c, Figure S1a, and S1b). Co₃O₄ NW consists of average diameter and length of 300 nm and 15 μm, respectively, and they exhibit rounded surface modulation, and grow in random directions with some wires crossing each other (FIG. 1d). The self-standing nature of NW array not only increases the active surface area, but also allows better diffusion of reactants through the empty spaces between the neighbouring NWs^{[18]}. Unlike most template-assisted growth of NW arrays, a simple chemical route employed here produces uniform and dense Co₃O₄ NW array over large areas, which leads to high surface area per unit volume for enhanced electrocatalytic oxygen reactions (FIG. 1e). Interestingly, the Co₃O₄NWs were actually tubular with a circular hollow centre of diameter 50 nm (FIG. 1f), which is ascribed to the Kirkendall effect during the formation of the NW.^{[19]} The inspection of SS mesh edge reveals a directly coupled NW array to the SS current collector (Figure S1c). The coupling allows a direct transfer of charges from the site of the electrocatalytic reaction to the current collector, greatly enhancing the charge transfer properties of the electrode.^{[18]} In addition, every NW is able to undergo an efficient electrochemical reaction since they are individually in contact with the current collector, resulting in a high active material utilization.^{[18, 20]} Further analysis reveals that the NW is actually mesoporous (FIG. 1g, Figure S2a, and S2b), which have been also confirmed by BET analysis by a Type IV isotherm (Figure S3). The HR-TEM image reveals fringes in multiple directions (FIG. 1h), and the crystal structure of the NW analyzed by Fast Fourier Transformation (FFT) reveals (111), (211), and (220) crystal orientations of a cubic spinel Co₃O₄(FIG. 1h, inset), indicative of the polycrystalline nature of the NW. In addition to the aforementioned advantages, the mechanical flexibility of the SS mesh allows bending of the electrode, which is interesting for the development of flexible device applications (FIG. 1i).

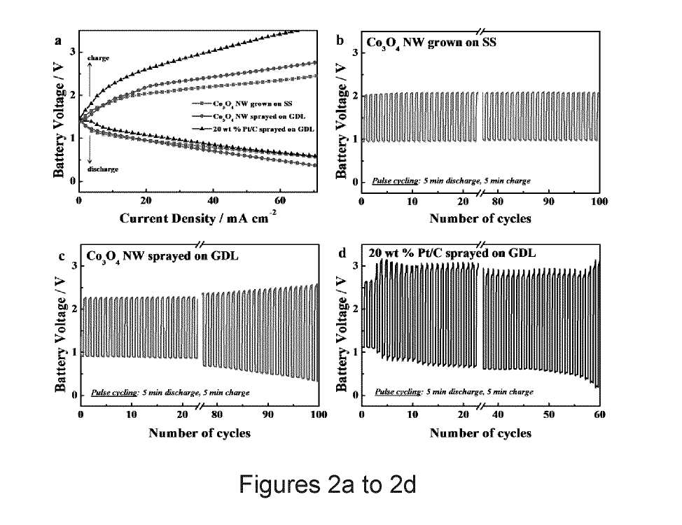

To investigate the catalytic activity of the advanced SS mesh electrode, a single-cell practical zinc-air battery has been used to demonstrate its performance in natural air (instead of pure oxygen). Superior discharge and charge potentials of the advanced SS mesh electrode are apparent in the galvanodynamic discharge and charge polarization profiles beyond 20 mA cm⁻² (FIG. 2a). However, at lower current densities, the conventional GDL electrode sprayed-coated with Co₃O₄ NW shows a comparable performance to that of the SS mesh electrode due to sufficiently low rate of reaction. The superior performance of the advanced SS mesh electrode at higher current densities is attributed to the hierarchical Co₃O₄ NW array with mesoporous morphology and the direct coupling of each NW onto the current collector for enhanced active material utilization and rapid charge transfer during the catalytic oxygen reactions. In the conventional GDL electrode, however, polymer binders used during the electrode preparation introduces highly undesirable interfaces, which reduces the surface utilization, resulting in inefficient electrocatalysis. Physically deposited material is also subjected to particle aggregation, which leads to the loss of active surface area and hindering the accessibility of electrolyte to the active material.^{[21]} Furthermore, physical deposition leads to random orientations of the active material, which loses the morphological benefit of nanosized array architecture. The state-of-art commercial Pt/C catalyst sprayed on a GDL demonstrates comparable discharge performance, but a significantly inferior charge performance. The rechargeability of the electrodes have been tested also using air in ambient conditions by the galvanostatic recurrent pulse method with each pulse cycle lasting 10 minutes (5 minute discharge/charge each) at a fixed current of 50 mA. The pulse cycling technique is an excellent diagnostic tool for evaluating the battery's rechargeability by switching the polarity of applied current in short intervals. The SS mesh electrode with directly grown Co₃O₄ NW array exhibits superior initial charge and discharge potentials of 2.0 and 0.98 V, respectively (FIG. 2b). Even after 100 pulse cycle, the discharge and charge potentials virtually have remained unchanged, which is indicative of excellent rechargeability. In fact, even after 1500 pulse cycles, the performance of the SS mesh electrode shows only a slight decrease in the discharge potential (Figure S7). In contrast, the conventional Co₃O₄ NW sprayed and Pt/C sprayed GDL electrodes show significant potential losses after 100 and 60 pulse cycles, respectively (FIGS. 2c and 2d). The carbon-based GDL and the polymer binder used to prepare the electrodes most likely have undergone deterioration.

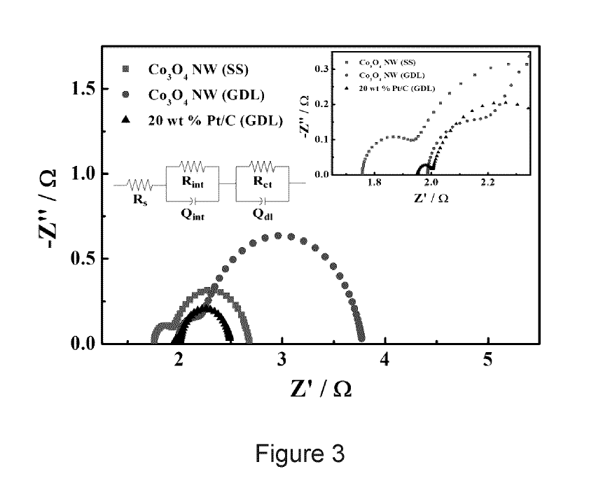

The evaluation of the enhanced electrical properties and the kinetics of the oxygen reactions of the advanced SS mesh electrode were performed by electrochemical impedance spectroscopy (EIS) (FIG. 3). A typical Nyquist plot of a single-cell practical zinc-air battery is composed of two semi-circles that correspond to different battery processes well-described by an equivalent circuit with five elements, Rₛ, Qᵢₙₜ, Rᵢₙₜ, Q_{dl}, and R_{ct} (FIG. 3, inset).^{[2, 22]} The values of these elements for each electrode investigated are listed in Table 1.

TABLE 1
The values of the equivalent circuit elements based
on the EIS analysis of Co₃O₄ NW grown on SS mesh,
Co₃O₄ sprayed on GDL, and Pt/C sprayed on GDL.

| | Co₃O₄ NW | Co₃O₄ NW | 20 wt % Pt/C |
|---|---|---|---|
| | grown on | sprayed on | sprayed on |
| Element | SS mesh | GDL | GDL |
| Rₛ [Ω] | 1.76 | 1.987 | 2.05 |
| Rᵢₙₜ [Ω] | 0.179 | 0.209 | 0.050 |
| R_{ct} [Ω] | 0.744 | 1.58 | 0.498 |
| Qᵢₙₜ [S · sⁿ] | 0.0378 | 0.0155 | 0.207 |
| Q_{dl} [S · sⁿ] | 1.49 × 10⁻³ | 9.73 × 10⁻⁴ | 2.55 × 10⁻³ |

The advanced SS mesh electrode shows significantly lower values for all three resistances, which again highlights the advantages of the hierarchical design of the air electrode. The lowest Rₛ value is attributed to the reduction of the internal resistance by directly coupling the active Co₃O₄ NW array onto the current collector and reducing the battery components required. In comparison, the conventional GDL electrode sprayed with Co₃O₄ NW exhibits much larger Rₛ likely due to randomly oriented NW (no longer individually self-standing) with possible particle aggregation. Rᵢₙₜ of the advance electrode is also much lower than that of the conventional electrodes as the interfacing of the NW array with electrolyte is much easier in the self-standing geometry and without the interference from the polymer binder. In addition, the advanced electrode exhibits much reduced R_{ct} compared to that of the conventional electrode, which is attributed to enhanced transfer of charges and greater active material utilization during the electrochemical reaction.

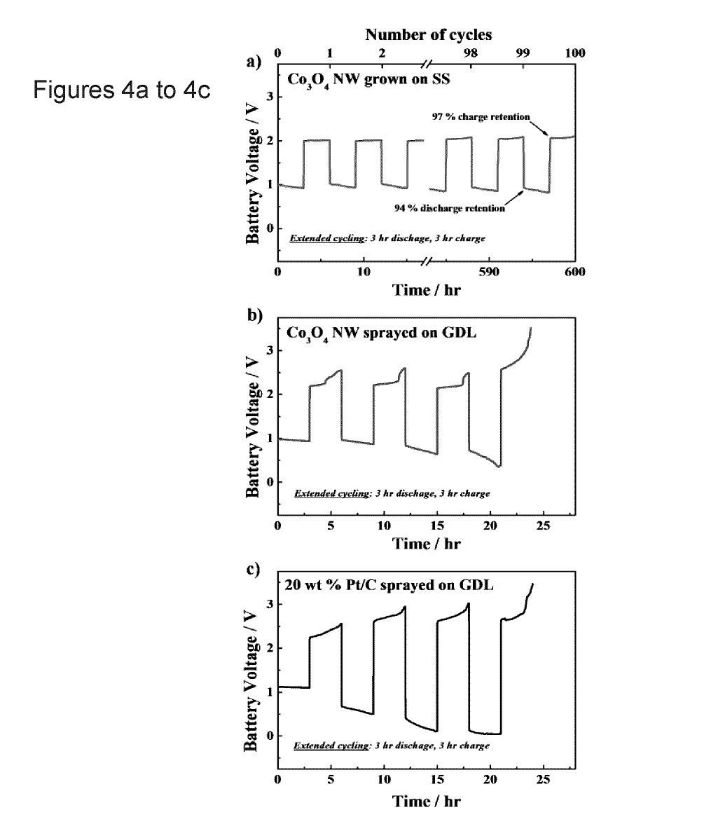

Building upon the demonstration of high functionality of the advanced electrode, its practicality is demonstrated by investigating the long term durability by the extended cycling test (3 hour discharge followed by 3 hour charge) in a practical zinc-air battery. The advanced SS electrode with directly coupled Co₃O₄ NW demonstrates excellent charge and discharge potentials, consistent with the pulse cycling (FIG. 4a). The discharge profiles show a shallow linear potential drop over the duration of the three hour battery discharge, which is ascribed to the gradual exhaustion of the hydroxide ions in the electrolyte during ORR, not due to the degradation in the performance of the electrode. The lack of hydroxide ions in the electrolyte can be simply refuelled in practice by utilizing a flow electrolyte battery design. The extended cycling of the advanced SS electrode shows remarkable charge and discharge potential retentions (97 and 94%, respectively) even after 100 cycles (nearly a month). The durability of a zinc-air battery with such excellent rechargeable potentials over this time-scale has never been reported (Figure S9). In comparison, the conventional GDL electrode demonstrates very poor rechargeability, lasting only four cycles (FIG. 4b). The peaks observed in the charge profiles of the conventional electrode, which are absent in those of the SS mesh electrode, are attributed to the carbon corrosion of the GDL and the polymer binder at higher charge potentials. These highly undesirable reactions lead to the physical degradation of the air cathode, significantly reducing the rechargeability of the zinc-air battery. The detrimental effect of using the conventional GDL is also observed with Pt/C sprayed electrode, where a significantly limited rechargeability of only four cycles is observed (FIG. 4c).

In summary, we propose an advanced air electrode with functionality and practicality for long term rechargeable zinc-air battery applications. The electrode is composed of hierarchical self-standing mesoporous Co₃O₄ NW array as highly active bi-functional catalyst for both ORR and OER. Co₃O₄ NW array is directly coupled to the underlying SS mesh current collector via a facile synthesis, which does not require the use of any ancillary material. The advanced electrode preparation also eliminates conventionally used physical deposition processes such as spray-coating or drop-casting. Compared to the conventional GDL electrodes, the advanced electrode exhibits superior charge and discharge potentials at high currents. Furthermore, 1500 pulse cycles are demonstrated without significant performance degradation, exhibiting excellent rechargeability. In addition, superior internal, interfacial, and charge transfer resistances of the advanced electrode have been confirmed by EIS, attributed to the advantages of directly coupling Co₃O₄ NW onto the current collector. Finally, remarkable electrochemical durability of the advanced electrode is observed utilizing air in ambient conditions, demonstrating extended cycling of 600 hours with charge and discharge potential retentions of 97 and 94%, respectively. This excellent longevity of the advanced electrode is attributed to the directly coupled Co₃O₄ NW array onto the SS mesh that remains intact and highly active even after extremely long battery operation.

Materials & Methods

The single-cell battery performance was tested using a home-made practical zinc-air battery and a multichannel potentiostat (Princeton Applied Research, VersaSTAT™ MC). A polished zinc plate (Zinc Sheet EN 988, OnlineMetals) and Co₃O₄ NW directly grown on SS mesh (Super fine #500 E-Cig™ 25 micron, The Mesh Company) were used as the anode and cathode, respectively. A Teflon-coated carbon fibre paper as a backing layer was placed next to the SS mesh to prevent electrolyte leakage. Microporous membrane (25 μm polypropylene membrane, Celgard™ 5550) and 6.0 M KOH were used as a separator and electrolyte, respectively. The area of the active material layer exposed to the electrolyte was 2.84 cm². For comparison, cathodes consisting of Co₃O₄ NW (scraped off from the SS mesh) and 20 wt % commercial Pt/C were spray-coated using an air brush onto a GDL with a loading of ca. 1.5 mg cm⁻², consistent with the average loading of Co₃O₄ NW directly grown on SS mesh. Briefly, 15 mg of active material was dispersed in 1 mL of isopropyl alcohol by sonication for 30 minutes. Then 107 μL of 5 wt % Nafion™ solution was added, followed by 1 hour of additional sonication. The catalyst mixture was sprayed onto the GDL then dried in an oven at 60° C. for 1 hour. The catalyst loading was determined by measuring the weight of the GDL before and after spray-coating. The discharge and charge polarization and power density plots were obtained by a galvanodynamic method with a current density ranging from 0 to 200 mA. The charge-discharge pulse cycling was conducted by a recurrent galvanic pulse method with a fixed current of 50 mA with each cycle being 10 minutes (5 minute discharge followed by 5 minute charge). The extended cycling was carried out by the same method but each cycle being 6 hours (3 hour discharge followed by 3 hour charge). The zinc plate was replaced every 20 cycles to study the durability of air cathode without the failure of battery due to the anode. Electrochemical impedance spectroscopy was conducted with a direct current (DC) voltage fixed at an ORR potential of 0.8 V with an alternating current (AC) voltage of 20 mV ranging from 100 kHz to 0.1 Hz to obtain the Nyquist plots.

Although the invention has been described with reference to certain specific embodiments, various modifications thereof will be apparent to those skilled in the art. Any examples provided herein are included solely for the purpose of illustrating the invention and are not intended to limit the invention in any way. Any drawings provided herein are solely for the purpose of illustrating various aspects of the invention and are not intended to be drawn to scale or to limit the invention in any way. The scope of the claims appended hereto should not be limited by the preferred embodiments set forth in the above description, but should be given the broadest interpretation consistent with the present specification as a whole. The disclosures of all prior art recited herein are incorporated herein by reference in their entirety.

### REFERENCES

[1] G. Girishkumar, B. McCloskey, A. C. Luntz, S. Swanson, W. Wilcke, Journal of Physical Chemistry Letters 2010, 1, 2193-2203.
[2] Z. Chen, A. Yu, D. Higgins, H. Li, H. Wang, Z. Chen, Nano Lett. 2012, 12, 1946-1952.
[3] J. Chen, F. Y. Cheng, Acc. Chem. Res. 2009, 42, 713-723.
[4] H. W. Park, D. U. Lee, L. F. Nazar, Z. Chen, J. Electrochem. Soc. 2013, 160, A344-A350.
[5] J. Wu, H. W. Park, A. Yu, D. Higgins, Z. Chen, The Journal of Physical Chemistry C 2012, 116, 9427-9432.
[6] Z. Chen, J. Y. Choi, H. J. Wang, H. Li, Z. W. Chen, J. Power Sources 2011, 196, 3673-3677.
[7] J. S. Lee, G. S. Park, H. I. Lee, S. T. Kim, R. G. Cao, M. L. Liu, J. Cho, Nano Lett. 2011, 11, 5362-5366.
[8] V. Neburchilov, H. J. Wang, J. J. Martin, W. Qu, J. Power Sources 2010, 195, 1271-1291.
[9] Z. Chen, M. Waje, W. Li, Y. Yan, Angew. Chem. 2007, 119, 4138-4141.
[10] T. Ioroi, N. Kitazawa, K. Yasuda, Y. Yamamoto, H. Takenaka, J. Electrochem. Soc. 2000, 147, 2018-2022.
[11] T. Yu, D. Y. Kim, H. Zhang, Y. Xia, Angewandte Chemie International Edition 2011, 50, 2773-2777.
[12] D. C. Higgins, S. Y. Ye, S. Knights, Z. W. Chen, Electrochemical and Solid State Letters 2012, 15, B83-B85.
[13] K. P. Gong, F. Du, Z. H. Xia, M. Durstock, L. M. Dai, Science 2009, 323, 760-764.
[14] Y. Liang, Y. Li, H. Wang, H. Dai, J. Am. Chem. Soc. 2013, 135, 2013-2036.
[15] Y. Li, M. Gong, Y. Liang, J. Feng, J.-E. Kim, H. Wang, G. Hong, B. Zhang, H. Dai, Nat Commun 2013, 4, 1805.
[16] K. H. Kangasniemi, D. A. Condit, T. D. Jarvi, J. Electrochem. Soc. 2004, 151, E125-E132.
[17] X. Wang, W. Z. Li, Z. W. Chen, M. Waje, Y. S. Yan, J. Power Sources 2006, 158, 154-159.
[18] Y. G. Li, B. Tan, Y. Y. Wu, Nano Lett. 2008, 8, 265-270.
[19] Y. D. Yin, R. M. Rioux, C. K. Erdonmez, S. Hughes, G. A. Somorjai, A. P. Alivisatos, Science 2004, 304, 711-714.
[20] Y. Y. Gao, S. L. Chen, D. X. Cao, G. L. Wang, J. L. Yin, J. Power Sources 2010, 195, 1757-1760.
[21] G. Binotto, D. Larcher, A. S. Prakash, R. H. Urbina, M. S. Hegde, J. M. Tarascon, Chem. Mater. 2007, 19, 3032-3040.
[22] D. Thiele, A. Züttel, J. Power Sources 2008, 183, 590-594.

1. A method of manufacturing a bi-functional electrode comprising:
providing a porous metal substrate; and,
chemically growing metal oxide nanowires on the metal substrate.

2. The method of claim 1, wherein the metal substrate is a porous metal substrate.

3. The method of claim 2, wherein the metal substrate is a mesh or a metal foam.

4. The method of claim 2, wherein the metal substrate is stainless steel, nickel, copper, aluminum or alloys thereof.

5. The method of claim 1, wherein the metal oxide nanowires comprise transition metal oxides or mixed transition metal oxides.

6. The method of claim 5, wherein the metal oxide nanowires comprise cobalt oxide, tin oxide, titanium oxide, nickel oxide, nickel cobalt oxide or cobalt manganese oxide.

7. The method of claim 1, wherein the step of chemically growing metal oxide nanowires comprises forming an aqueous solution of a salt of the metal forming the metal oxide and a hydroxide and treating the metal substrate with said solution, whereby the metal oxide nanowires are formed and grown on the metal substrate.

8. The method of claim 7, wherein the hydroxide comprises ammonium hydroxide, sodium hydroxide or potassium hydroxide.

9. The method of claim 1, further comprising heat treating the metal substrate having metal oxide nanowires.

10. The method of claim 3, wherein the metal substrate is stainless steel, nickel, copper, aluminum or alloys thereof.

11. The method of claim 10, wherein the metal oxide nanowires comprise transition metal oxides or mixed transition metal oxides.

12. The method of claim 11, wherein the metal oxide nanowires comprise cobalt oxide, tin oxide, titanium oxide, nickel oxide, nickel cobalt oxide or cobalt manganese oxide.

13. The method of claim 12, wherein the step of chemically growing metal oxide nanowires comprises forming an aqueous solution of a salt of the metal forming the metal oxide and a hydroxide and treating the metal substrate with said solution, whereby the metal oxide nanowires are formed and grown on the metal substrate.

14. The method of claim 13, wherein the hydroxide comprises ammonium hydroxide, sodium hydroxide or potassium hydroxide.
